(19) United States
(12) Patent Application Publication
(10) Pub. No.: US 2016/0378087 A1
(43) Pub. Date: Dec. 29, 2016

(54) SYSTEM, METHOD AND COMPUTER PROGRAM PRODUCT OF PERFORMING SITUATIONAL CONTROL USING A STATE DIAGRAM

(71) Applicant: NATIONAL TAIPEI UNIVERSITY OF TECHNOLOGY, Taipei (TW)

(72) Inventors: Hsien I LIN, Taipei (TW); Yu Che HUANG, Taipei (TW)

(21) Appl. No.: 14/748,233

(22) Filed: Jun. 24, 2015

(51) Int. Cl. G05B 19/05

(52) U.S. Cl. CPC G05B 19/056; G05B 2219/13108; G05B 2219/13046

(57) ABSTRACT

The present disclosure illustrates a system, a method and a computer program product of performing situational control using a state diagram. In the present disclosure, a state diagram including state nodes, state transfer indications and internal computing functions is provided, and a control is transferred to the state nodes according to the state transfer indications, and a common decision is then made by executing the internal computing function of the state nodes getting the control, so as to perform a technical means of situational control for the decision role. Therefore, the present disclosure not only uses the graphic control system to perform the situational control by making the common decision, but also achieves a technical effect of a safer and comprehensive control output.

### BACKGROUND OF RELATED ART

Technical Field

The present disclosure relates to a system, a method and a computer program product of performing situational control, and particularly to a system, a method and a computer program product of performing the situational control using a state diagram.

Background Art

A HMI/MMI (Human/Man Machine Interface) is an interactive technology between humans and machines, and usually based on computer programming software. The HMI/MMI is often applied to building automation systems, factory automation systems, and security automation systems and so on. Because of progress in computer technologies, functions of current HMI/MMI are more efficient to be operated than that of previous HMI/MMI a couple of years ago, and a most popular function of them often uses a graphic module as a communicating interface. Therefore, related developing operators of HMI/MMI systems in Taiwan often call the HMI/MMI system as “graphic control system”.

The graphic control system is required and estimated by several issues, such as interactive interface, multimedia graphic control, user-friendly interface, high quality, low cost, energy conservation, product standardization, value-added function, and so forth.

Existing HMI/MMI systems or graphic control systems on the market may be divided into three subsystems which are database, logic control and graphic display. Now the graphic control system is inclined to develop more platforms or complex statements, and the logic control is planned by writing VB grammar or homemade grammar, or it may be planned by function blocks. However, using the grammar description or function blocks to plan the control logic needs a planned manner of an inputting, a main function and an outputting, and this planned manner often has a situation that an end point is generated due to single output or an infinite loop is entered, and it is hard to perform a situational control by making a common decision. Besides, there is not ideal way to plan the control logic by using the grammar description or the function block, because these two manners are not instinctive for humans and cannot be used simply.

In addition, an existing graphic control system integrates multiple UCPs (Unit Control Panel) by a way of parallel processing, but this way may easily result in a situation that UCPs work independently without connecting to each other. Thus, the common decision may not be made.

In summary, the problem of the graphic control system hardly performing the situational control by generating the common decision is existed in prior arts for a long time. As a result, it is necessary to propose an improved technical means to solve the problem.

### SUMMARY

According to the problem of the common decision hardly made by the graphic control system for performing the situational control in the prior arts, the present disclosure illustrates a system, a method and a computer program product of performing the situational control using a state diagram.

The disclosed system of performing a situational control using the state diagram, is applied to a graphic control system. The system includes a state edit module, a target defining module and a situational control module. The state edit module is used to provide a state diagram for editing a control logic, and the state diagram includes state nodes, state transfer indications and internal computing functions of the state nodes. The target defining module is used to define a decision role executing the control logic. The situational control module is used to transfer a control to a state node according to a state transfer indication and then make a common decision by executing the internal computing function of the state node getting the control, so as to perform a situational control for the decision role.

The disclosed method of performing a situational control using a state diagram is applied to a graphic control system. The method includes following steps. A state diagram is provided for editing a control logic, and the state diagram includes state nodes, state transfer indications and internal computing functions of the state nodes. A decision role executing the control logic is defined. A control is transferred to a state node according to a state transfer indication, and then a common decision is made by executing the internal computing function of the state node getting the control, so as to perform a situational control for the decision role.

The disclosed computer program produce of performing a situational control using a state diagram, includes computer software. The computer software is loaded into a computer for performing following steps. A user interface including a graphic edit region is provided. A state diagram for editing a control logic in the graphic edit region is provided, and the state diagram includes state nodes, state transfer indications and internal computing functions of the state nodes. A decision role executing the control logic is defined. A control is transferred to a state node according to a state transfer indication, and a common decision is then made by executing the internal computing function of the state node getting the control, so as to perform a situational control for the decision role.

The disclosed system, method, and computer program product are shown as above. The major difference between the prior arts and the present disclosure is that the present disclosure provides a state diagram including the state nodes, the state transfer indications and the internal computing functions for editing, and the control is transferred to the state node according to the state transfer indication, and a common decision is then made by executing the internal computing function of the state node getting the control, so as to perform situational control for the decision role. Thus, the present disclosure not only solves an existed problem in the prior arts, but also achieves a technical effect of a safer and comprehensive control output.

### BRIEF DESCRIPTION OF THE DRAWINGS

The invention will become more fully understood from the detailed description given herein below illustration only, and thus is not limitative of the present disclosure, and wherein:

FIG. 1 is an architecture diagram of a system using a state diagram to perform a situational control, in accordance with the present disclosure.

FIG. 2 is a user interface diagram of using a state diagram to perform a situational control, in accordance with the present disclosure.

FIG. 3 is a flow chart of a method of using a state diagram to perform a situational control, in accordance with the present disclosure.

FIG. 4 is a state diagram according to the embodiment in accordance with the present disclosure.

FIG. 5A to FIG. 5F are state grammar diagrams according to the embodiment of the present disclosure.

### DETAILED DESCRIPTION

The present disclosure will be apparent from the following detailed description, which proceeds with reference to the accompanying drawings, wherein the same references relate to the same elements.

The present disclosure may provide a user a state diagram to edit a control logic for a decision role, and after completing the editing of the state diagram, a control may be transferred to different state nodes continuously according to the state diagram, such that each of the state nodes may make a common decision together, so as to perform situational control for the decision role.

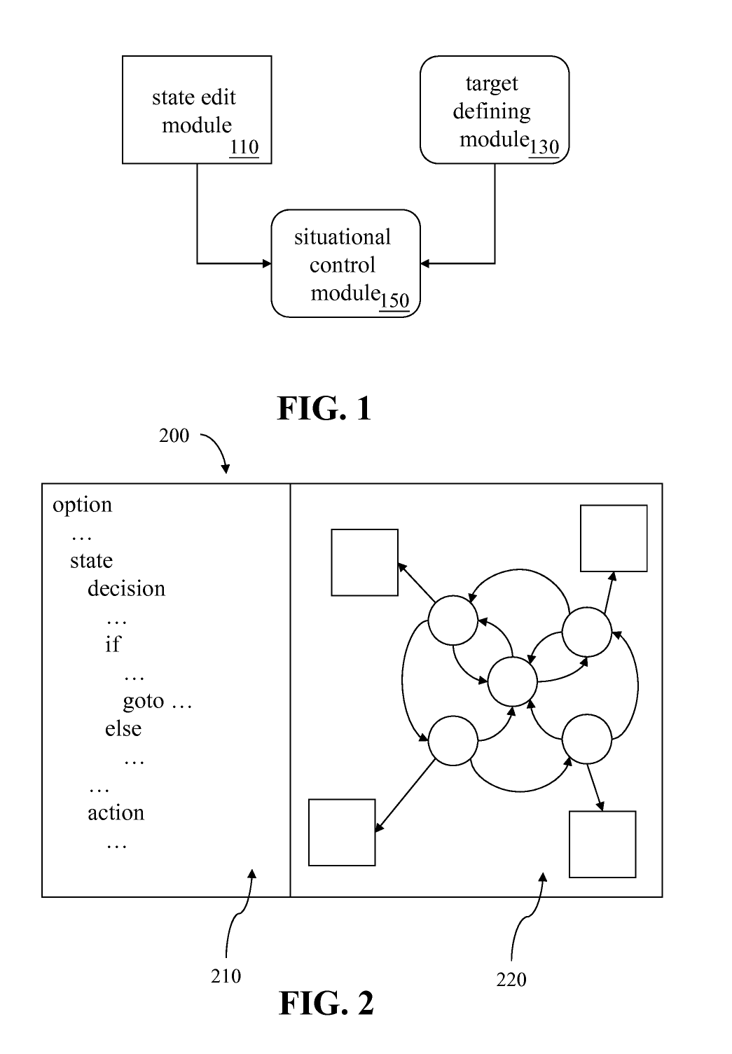

Please refer to FIG. 1 which is an architecture diagram of a system of using a state diagram to perform a situational control, in accordance with the present disclosure. As shown in FIG. 1, the system of the present disclosure has a state edit module 110, a target defining module 130 and a situational control module 150.

The state edit module 110 is configured for editing a state diagram. The state diagram of the present disclosure includes multiple state nodes, at least one state transfer indication and multiple internal computing functions. In some embodiments of the present disclosure, the state diagram may further include state transfer conditions.

In the state diagram, the state node is often indicated by a circle and one state node indicates a state. Each different state node may correspond to the at least one different internal computing function, but it may not correspond to any internal computing function as well. The state transfer indication is usually indicated by an arrow. One state transfer indication may connect two state nodes or exist between two state nodes, to express that the control is transferred from a state node to the other state node. In addition, the state transfer indication of a state node may be directed to the same state node as well. The internal computing function is usually indicated by a rectangle and each of the internal computing function is corresponding to a state node. However, the present disclosure is not limited to the aforesaid patterns. The present disclosure may also use the patterns which can distinguish the state nodes from the internal computing functions and express the indicating manner of the state transfer.

It is worth mentioning that if at least two state transfer indications in the state diagram are directed from the same state node to different state nodes, each of the state transfer indications may also correspond to a different state transfer condition accordingly. When the internal computing function of the state node is satisfied with a state transfer condition, a state transfer indication corresponding to the state transfer condition may be chosen, such that the control may be transferred to the other state node according to the state transfer indication which is chosen. In addition, the state node and/or the internal computing function may also have priority accordingly. When at least two state transfer indications may be chosen, the state transfer indication which transfers to the state node with the highest priority or corresponding to a state node whose internal computing function with the highest priority will be chosen.

The state edit module 110 can not only edit a state diagram, but also edit a state grammar. The state grammar includes a role description, at least one node description, at least one transfer description, at least one behavior description, and so on. In some embodiments of the present disclosure, the state grammar further includes condition descriptions. In addition, the role description corresponding to the decision role using the state diagram, is used to express the decision role. The role description may include at least one node description which is used to express the state node. One node description corresponds to one state node, and a node description may include at least one transfer description and at least one behavior description, and a node description may include at least one condition description as well. The transfer description is used to express the state transfer indication, and the status description has a one-on-one relationship with the state transfer indication. The behavior description is used to express the internal computing function of the state node including the behavior description. A behavior description corresponds to an internal computing function. The condition description is used to express the state transfer condition, and the condition description has a one-on-one relationship with the state transfer condition.

For example, the state grammar may use keywords of “option”, “state” and “action” to express the decision role, the state node and the internal computing function, respectively. The keyword of the state transfer indication may use “decision . . . goto . . .” to express that the control is transferred to the other state node, or use “decision . . . stay” to express that the control is transferred to the same state node. In other words, the control is not moved. Besides, the condition description may use “if . . . else . . . ” as the keyword.

The state edit module 110 may transform the state diagram provided for editing to a corresponding state grammar, and also transform the state grammar provided for editing to the state diagram. That is, when the state diagram is edited or the editing for the state diagram is completed, the state edit module 110 may generate or adjust the state grammar according to the state diagram, to enable the state grammar to correspond to the state diagram. When the state grammar is edited or the editing for the state grammar is completed, the state edit module 110 may generate or adjust the state diagram according to the state grammar, to enable the state diagram to correspond to the state grammar.

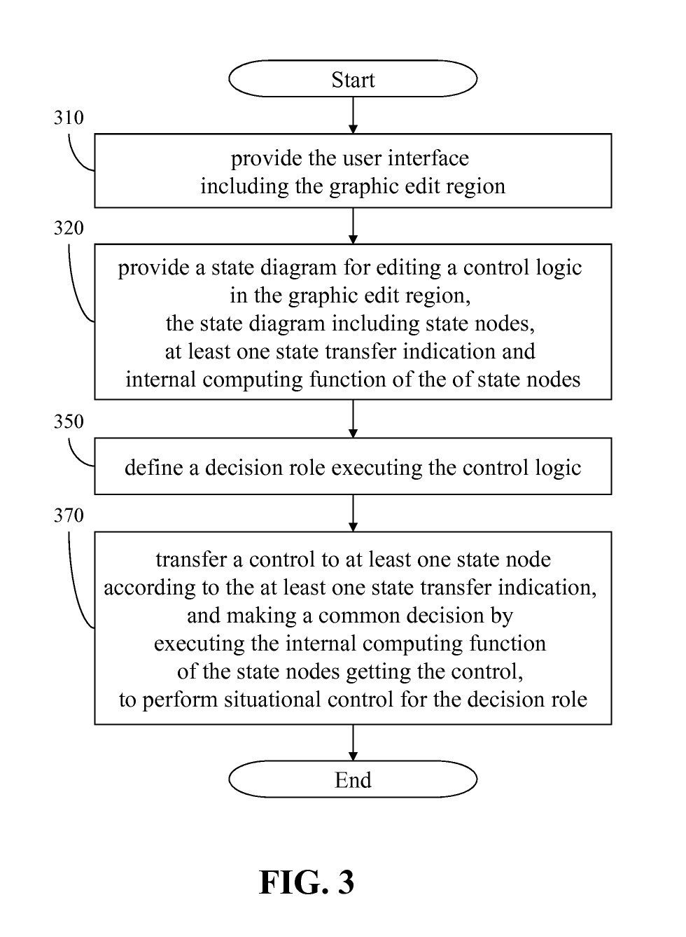

Generally speaking, the state edit module 110 may provide a user interface for editing the state diagram. The user interface provided by the state edit module 110 may include a graphic state edit region for editing the state diagram. If the state edit module 110 is used to provide the state grammar for editing, the user interface provided by the state edit module 110 may further include a grammar edit region for editing the state grammar, such as the user interface 200 illustrated in FIG. 2. However, the user interface of the present disclosure is not limited to the user interface 200 in FIG. 2. For example, in FIG. 2, when the user edits the state diagram in the graphic edit region 220, the state edit module 110 may generate a corresponding state grammar based on the edited state diagram, and may display the generated state grammar in the grammar edit region 210. The user may pause editing the state diagram, and then edit the generated state grammar in the grammar edit region 210 instead. Similarly, the state edit module 110 may adjust the state diagram edited in the graphic region 220 edited by the user according to the edited state grammar, to enable the state grammar in the grammar edit region 210 to correspond to the state diagram in the graphic edit region 220.

The target defining module 130 is configured to define a decision role executing the control logic.

The situational control module 150 is configured to transfer the control to at least one state node according to at least one state transfer indication, such that the internal computing function may be executed by the at least one state node getting the control and a common decision can be made by all the at least one state node, so as to perform situational control for the decision role. More specifically, the situational control module 150 may transfer the control to one state node according to one state transfer indication, such that the internal computing function of the state node getting the control may be executed, and the other state transfer indication is chosen by a result of executing the internal computing function, and then the control is transferred to the same state node or the other state node again according to the other state transfer indication being chosen, so as to execute the internal computing function of the other state node getting the control. Next, the other state transfer indication is chosen by a result of executing the internal computing function, and then the control will be transferred again. Thus, the control will be transferred among the at least one state node constantly, such that all the at least one state node may make a common decision together.

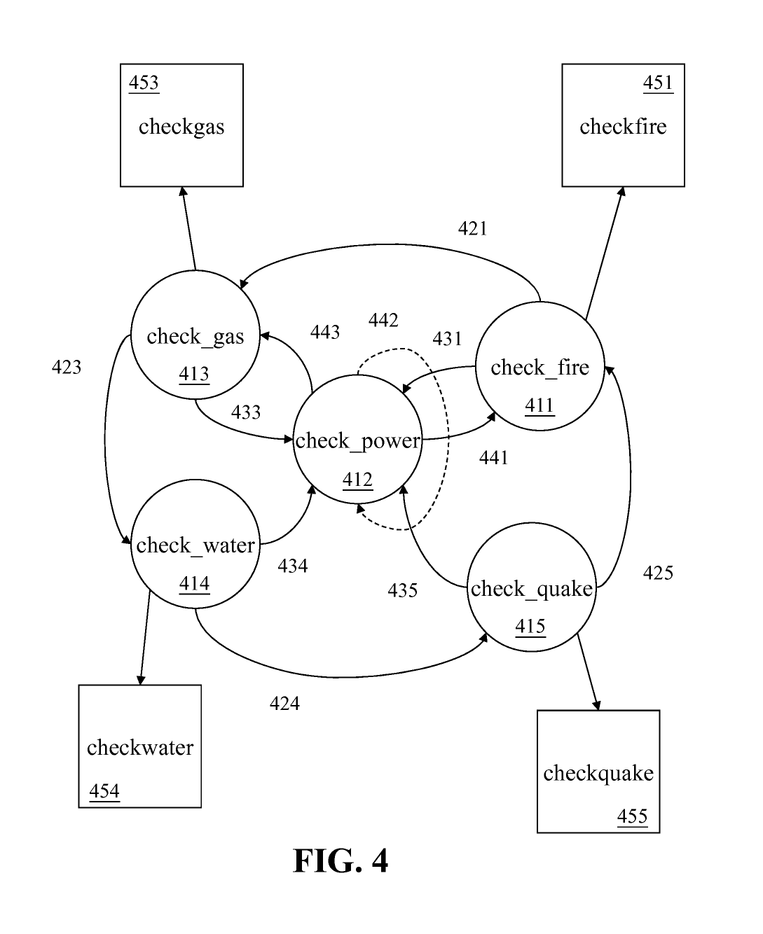

Next, an embodiment is taken as an example for explaining the operating system and method thereof of the present disclosure. Please refer to FIG. 3 which shows a flow chart of method of using a state diagram to perform a situational control of the present disclosure. The present embodiment assumes that disasters of fire, water, gas, quake and power supplying status have to be monitored at the same time, and it also wishes that a common decision may be made by the present disclosure.

At first, in the step of 320, the state edit module 110 may provide the user a state diagram for editing a control logic for a decision role. In the present embodiment, it assumes that the state edit module 110 may provide the user interface 200 including the graphic edit region 220 and the grammar edit region 210 to the user (step 310), such that the user may edit the state diagram on the user interface (step 320).

The user may edits the state diagram in the graphic edit region 220 first, such that the state edit module 110 may generate the state grammar according to the corresponding state diagram which is edited by the user, and it may also display the state grammar in the grammar edit region 210. Next, the user may pause editing the state diagram in the graphic edit region 220, and edit the state grammar displayed in the grammar edit region 210 instead. That is, the user may add, modify or delete the state grammar displayed in the grammar edit region 210. The state edit module 110 may adjust the state diagram in the graphic edit region 220 according to the state grammar which is edited by the user, so that the state diagram in the graphic edit region 220 may correspond to the state grammar in the grammar edit region 210. Then, the user may edit the state diagram which has been adjusted by the state edit module 110 in the graphic edit region 220 in the same way. The state edit module 110 may also adjust the state grammar in the grammar edit region 210 according to the state diagram which has been adjusted by the user. Similarly, the user may also edit the state grammar in the grammar edit region 210 first, such that the state edit module 110 may generate the state diagram according to the corresponding state grammar which has been edited by the user, and display the state diagram generated in the graphic edit region 220. Next, the user may edit the state diagram in the graphic edit region 220 instead. The state edit module 110 adjusts the state grammar displayed in the grammar edit region 220 according to the state diagram which has been edited by the user as well, such that the state grammar in the grammar edit region 210 can correspond to the state diagram in the graphic edit region 220. The user may then edit the state grammar which has been adjusted by the state edit module 110 in the grammar edit region 210 again. The state edit module 110 may also adjust the state diagram in the graphic edit region 210 according to the state grammar which has been adjusted by the user. By repeating the above steps, the state edit module 110 will adjust the state diagram or the state grammar corresponding to the state grammar or the state diagram which has been edited by the user, and the state diagram may be kept corresponding to the state grammar.

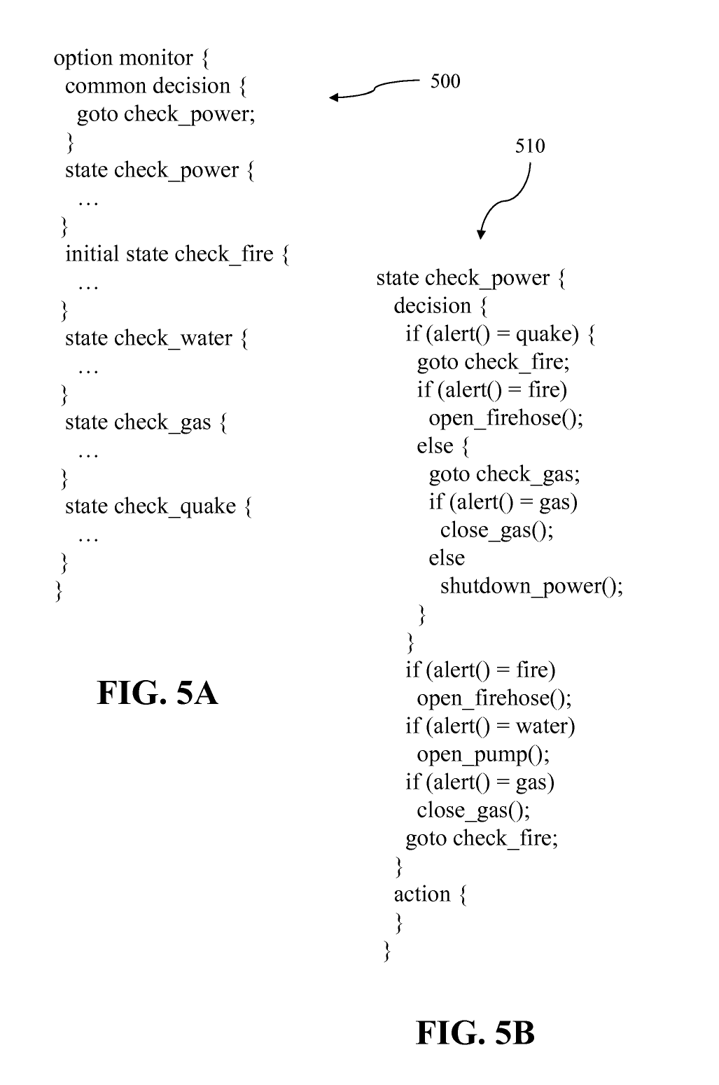

If the state diagram 400 which has been completed for editing by the user is shown as FIG. 4, it may include five state nodes 411 through 415, eleven state transfer indications 421 through 443, and four internal computing functions 451 through 455. The state node 411 corresponds to the internal computing function 451, the state node 413 corresponds to the internal computing function 453, the state node 414 corresponds to the internal computing function 454, and the state node 415 corresponds to the internal computing function 455.

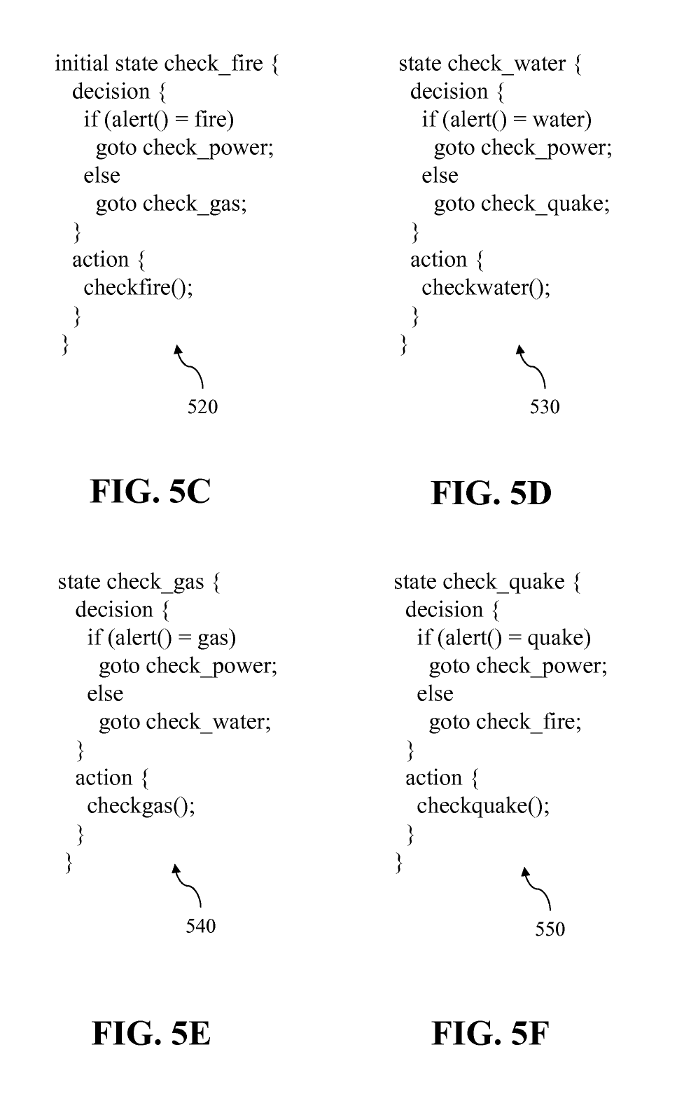

Furthermore, the state grammar 500 corresponding to the state diagram 400 is shown as FIG. 5A through FIG. 5F. The state grammar 510 in the FIG. 5B presents the state node 412 and three state transfer indications 441 through 443, the state grammar 520 in the FIG. 5C may be generated by the state node 411 and two state transfer indications 421 and 431, the state grammar 530 in the FIG. 5D may be generated by the state node 413 and two state transfer indications 423 and 433. The state grammar 540 in the FIG. 5E may be generated by the state node 414 and the state transfer indication 434, and the state grammar 550 in the FIG. 5E may be generated by the state node 415 and the state transfer indication 435.

After the user has completed editing the state diagram provided by state edit module 110, the target defining module 130 may define the decision role executing the control logic presented in the state diagram edited by the user (step 350).

Next, the situational control module 150 may transfer the control to the state node according to the state transfer indication in the state diagram, such that the internal computing function of the state node getting the control may be executed. By transferring the control to each of state nodes constantly, the common decision may be made by each of the state node together, and the situational control may be performed for the decision role (step 370). In the present embodiment, the state node 411 is at an initial state. After the state node 411 gets the control, the internal computing function 451 thereof will be executed, and the state transfer indication 421 or the state transfer indication 431 may be chosen by the result of executing the internal computing function 451, such that the control may be transferred to the state node 413 or the state node 412. After the state node 413 gets the control, the internal computing function 453 thereof will be executed, and the state transfer indication 423 or the state transfer indication 433 may be chosen by the result of executing the internal computing function 453, such that the control may be transferred to the state node 414 or the state node 412. Similarly, after the state node 414 gets the control, the internal computing function 454 thereof will be executed, and the state transfer indication 424 or the state transfer indication 434 may be chosen by the result of executing the internal computing function 454, such that the control may be transferred to the state node 415 or the state node 412. After the state node 415 gets the control, the internal computing function 455 thereof will be executed, and the state transfer indication 425 or the state transfer indication 435 may be chosen by the result of executing the internal computing function 455, such that the control may be transferred to the state node 411 or the state node 412. In addition, after the state node 412 gets the control, it may choose the state transfer indications according to the results of executing the internal computing functions (451, 453˜455) corresponding to the state node 411, state node 413, state node 414 and state node 415, respectively. When the state transfer indication 441 or the state transfer indication 443 is chosen, the control may be transferred to the state node 411 or the state node 413. And, when the state transfer indication 442 is chosen, the control is transferred to the state node 412, that is, the control is not transferred from the state node 412 because it is obtained by the state node 412 again. As the above descriptions, the common decision may be made by transferring the control among each of the state nodes.

In summary, the major difference between the prior arts and the present disclosure is that a state diagram including the state nodes, the state transfer indications and the internal computing functions is provided for editing in the present disclosure, and it transfers the control to the state nodes according to the state transfer indications, and then makes the common decision by executing the internal computing function of the state nodes getting the control, so as to perform a technical means of situational control for the decision role. By the technical means, the problem of the common decision being hardly made by the graphic control system for performing the situational control in the prior arts can be solved, so as to achieve a technical effect of a safer and comprehensive control output.

Further, the disclosed method of performing the situational control using the state diagram may be implemented in the hardware, the software or a combination of the hardware and the software, and it may be implemented in the computer system in a centralized manner or in different parts distributed in computer systems which are connected to each other.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of performing situational control using a state diagram, applied to a graphic control system, the method comprising steps at least:
providing a state diagram for editing a control logic, the state diagram comprising a plurality of state nodes, at least one state transfer indication and internal computing function of each of the state nodes;
defining a decision role executing the control logic; and
transferring a control to at least one of the state nodes according to the at least one state transfer indication, and making a common decision by executing the internal computing function of the at least one of the state nodes getting the control, to perform situational control for the decision role.

2. The method according to claim 1, the step of transferring the control to the at least one of the state nodes according to the at least one state transfer indication, and then making a common decision by executing the internal computing function of the at least one of the state nodes getting the control further comprising:
transferring the control to one of the state nodes according to one of the at least one state transfer indication;
executing the internal computing function of the one of the state nodes getting the control, and then choosing the other of the at least one state transfer indication by a result of executing the internal computing function of the one of the state nodes getting the control; and
transferring the control to the one of the state nodes again according to the other of the at least one state transfer indication chosen, so as to execute the internal computing function of the other of the state nodes getting the control.

3. The method according to claim 2, wherein in the step of choosing the other of the at least one state transfer indication by the result of executing the internal computing function of the one of the state nodes getting the control, the other of the at least one state transfer indication is chosen by negotiating with priority in each of the state nodes and/or each of the internal computing function of each of the state nodes.

4. The method according to claim 1, the step of providing the state diagram for editing the control logic further comprising:
providing a state grammar corresponding to the state diagram, and generating or adjusting the state diagram by the state grammar.

5. The method according to claim 1, before the step of providing the state diagram for editing the control logic, further comprising a step of providing a user interface for editing the state diagram;
wherein the user interface comprises a graphic edit region, or the graphic edit region and the grammar edit region.

6. A system of performing situational control using a state diagram, applied to a graphic control system, the system comprising at least:
a state edit module, used to provide a state diagram for editing a control logic, the state diagram comprising a plurality of state nodes, at least one state transfer indication and internal computing function in each of the state nodes;
a target defining module, used to define a decision role executing the control logic; and
a situational control module, used to transfer a control to at least one of the state nodes according to the at least one state transfer indication, and then make a common decision by executing the internal computing function of the at least one of the state nodes getting the control, to perform the situational control for the decision role.

7. The system according to claim 6, wherein the situational control module transfers the control to one of the state nodes according to one of the at least one state transfer indication, so that after the internal computing function of the one of the state nodes getting the control is executed, the situational control module chooses the other of the at least one state transfer indication by a result of executing the internal computing function of the one of the state nodes getting the control, and transfers the control to the other of the state nodes again according to the other of the at least one state transfer indication generated, to execute the internal computing function of the other of the state nodes getting the control.

8. The system according to claim 7, wherein each of the state nodes and/or each of the internal computing function of the each of the state nodes further comprise a priority, and the situational control module further uses the priority to choose the other of the at least one state transfer indication.

9. The system according to claim 6, wherein one of the state nodes is indicated by a circle, one of the at least one state transfer indication is indicated by an arrow, and one of the internal computing function of the each of the state nodes is indicated by a rectangle.

10. The system according to claim 6, wherein the state diagram further comprises at least one state transfer condition, and each of the at least one state transfer condition is used for providing one of the at least one state transfer indication to be chosen.

11. The system according to claim 6, wherein the state edit module is further used to edit a state grammar corresponding to the state diagram, and the state edit module generates or adjusts the state diagram by the state grammar.

12. The system according to claim 6, wherein the state grammar comprises at least:
a role description, used for expressing the decision role;
at least one node description, and each of the at least one node description used for expressing one of the state nodes;
at least one transfer description, and each of the at least one transfer description used for expressing one of the at least one state transfer indication; and
at least one behavior description, and each of the at least one behavior description used for expressing each of the internal computing function of each of the state nodes.

13. The system according to claim 6, wherein the state grammar further comprises at least one condition description, and one of the at least one condition description is used for providing one of the at least one state transfer indication to be chosen.

14. The system according to claim 6, wherein the state edit module provides a user interface for editing the state diagram, and the user interface comprises a graphic edit region.

15. The system according to claim 14, wherein the user interface further provides a grammar edit region for editing.

16. A computer program product of performing situational control using a state diagram, comprising computer software, and the computer software being loaded into a computer for performing steps:
providing a user interface comprising a graphic edit region;
providing a state diagram for editing a control logic in the graphic edit region, and the state diagram comprising a plurality of state nodes, at least one state transfer indication and internal computing function in each of the state nodes;
defining a decision role executing the control logic; and
transferring a control to at least one of the state nodes according to the at least one state transfer indication, and then making a common decision by executing the internal computing function of the at least one of the state nodes getting the control, to perform the situational control for the decision role.

17. The computer program product according to claim 16, wherein the step of using the computer software to transfer the control to the at least one of the state nodes according to the at least one state transfer indication, and then making the common decision by executing the internal computing function of the at least one of the state nodes getting the control, further comprises:
transferring the control to one of the state nodes according to one of the at least one state transfer indication;
after the internal computing function of at least one of the state nodes getting the control is executed, choosing the other of the at least one state transfer indication by a result of executing the internal computing function of at least one of the state nodes getting the control; and
transferring the control to the other of the state nodes again according to the other of the at least one state transfer indication generated, to execute the internal computing function of the other of the state nodes getting the control.

18. The computer program product according to claim 17, wherein in the step of using the computer software to make the computer choose the other of the at least one state transfer indication by the result of executing the internal computing function of at least one of the state nodes getting the control, the other of the at least one state transfer indication is chosen by negotiating with priority in each of the plurality of state nodes and/or each of the internal computing function of each of the state nodes.

19. The computer program product according to claim 16, wherein the step of using the computer software to provide the state diagram of editing the control logic in the graphic edit region further comprises:
providing a state grammar corresponding to the state diagram, and generating or adjusting the state diagram by the state grammar.
